(19) United States
(12) Patent Application Publication
(10) Pub. No.: US 2013/0319198 A1
(43) Pub. Date: Dec. 5, 2013

(54) CONTROL DEVICE FOR PAPER PUNCH

(71) Applicant: Tsung-Wen HUANG, Ping Ho Vill (TW)

(72) Inventor: Tsung-Wen HUANG, Ping Ho Vill (TW)

(21) Appl. No.: 13/487,291

(22) Filed: Jun. 4, 2012

(51) Int. Cl. B26D 5/08

(52) U.S. Cl. 83/588

(57) ABSTRACT

A paper punch includes multiple punch units, a cover and a slide member. Each paper unit has a punch body and a blade, the punch body has a passage through which the blade is movable relative to the punch body by the spring. The blade has a passive tooth on the top thereof. The cover is mounted to outside of the punch unit and has a closed top in which a slide slot is defined. The slide member is slidable along the slide slot and has an active gear which is engaged with the passive tooth of the punch unit. When moving the slide member, the blade is lowered because the active gear drives the passive tooth. The cross section of the blade is changed to punch different shapes of holes through the paper sheets.

### FIELD OF THE INVENTION

The present invention relates to a paper punch, and more particularly, to a paper punch which is equipped with a control device for punching different shapes of holes.

### BACKGROUND OF THE INVENTION

The conventional paper punch is used to punch holes along one side of the paper sheets which are then organized and collected conveniently. The conventional paper punch generally punches two holes and some of the punches are able to punch more than two holes. Taiwan Patent Publication No. 241219 discloses a paper punch as shown in FIG. 8 and comprises rail 81 on the base 80 of the paper punch and the rail 81 has multiple punch units 85 connected thereto. Each cylindrical punch unit 85 has a pin 84 extending transversely therethrough and the pin 84 is cooperated with a spring and connected to the rail 81. The two ends of the pin 84 are exposed beyond the rail 81 and the pin 84 is movable longitudinally by the spring. The rail 81 has a slide member 82 which has curved guide part 83 which has a protrusion at the central bottom thereof. The guide part 83 allows the pin 84 to pass. The punch unit 85 is kept at the higher position by the spring and when the slide member 82 moves along the rail 81, the slide member 82 guides the pin 84 by the guide part 83 so that the guide part 83 has a height difference along the longitudinal direction of the punch unit 85. When slide member 82 moves along the rail 81, the guide part 83 guides the pin 84 to move up and down. The pin 84 is lowered by the operation portion 831 of the guide part 83 and the punch unit 85 is moved downward with the pin 84 so as to punch holes through the paper sheets. The pin 84 bounces upward by the operation portion 831 of the guide part 83. By moving the slide member 82 along the rail 81, the guide rail 81 guides the pin 84 and the punch unit 85 up and down. When the punch unit 85 moves downward, the punch unit 85 punches a hole through the paper sheets.

However, the conventional paper punch is able to punch holes through the paper sheets, the shape of the holes that punched by the conventional paper punch is circular hole. In other words, the wall of the cylindrical punch unit 85 is thick enough so that the pin 84 transversely extends through the punch unit 85. Nevertheless, when the shape of the holes to be punched is mushroom shaped as shown in FIG. 9, the conventional punch unit 90 cannot make it. This is because the thickness of the wall of the blade 91 of the punch unit 90 is too thin to allow the pin 92 to extend through. The blade 91 of the punch unit 90 may be broken by the pin 92.

The present invention intends to provide a punch unit which is able to punch circular holes or mushroom shaped holes.

### SUMMARY OF THE INVENTION

The present invention relates to a paper punch and comprises multiple punch units and each paper unit has a stationary punch body and a blade. The punch body has a passage defined therethrough and the blade has a cross section complementary to the passage. The blade extends through the passage and has a first end thereof with a punch end and a second end thereof being a passive tooth. A spring is mounted to the blade which is movable relative to the punch body by the spring. The cover is mounted to outside of the punch unit and has a closed top. A slide slot is defined in the closed top and faces the punch units which are located along a straight line. A slide member is slidable along the slide slot and has an active gear rotatably connected thereto. The active gear passes through the slide slot and extends into the cover. The active gear is engaged with the passive tooth of the punch unit when moving the slide member. The blade is lowered and passes through the passage to punch holes.

The primary object of the present invention is to provide a punch unit which is able to punch circular holes or mushroom like holes while the structural strength of the punch unit is maintained.

The blade can be replaced when different shapes of holes are to be punched by the paper punch of the present invention, the structure of the paper punch does not need to be changed. The slide member rotates the active gear which drives the passive tooth of the punch units so as to lower the punch unit when sliding the slide member. Therefore, the punch unit and the slide member do not need to change, and only the blade is to be changed when different shapes of holes are to be punched.

The way that the punch units are driven is by the use of the active gear and the passive tooth of each of the punch unit. The punch units are lowered to punch in sequence by sliding the slide member.

Another object of the present invention is to provide a punch unit wherein the transmission means between the slide member and the punch unit is a gear, so that the cross section of the can be changed to punch different shapes of holes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the paper punch of the present invention;

FIG. 2 is an exploded view to show the paper punch of the present invention;

FIG. 3 shows the active gear and the punch unit of the paper punch of the present invention;

FIG. 4 shows that the punch unit is lowered by sliding the slide member;

FIG. 5 shows that another punch unit is lowered by sliding the slide member;

FIG. 6 is a perspective view to show mushroom like holes are punched by the paper punch of the present invention;

FIG. 7 is a perspective view to show circular holes are punched by the paper punch of the present invention;

FIG. 8 is a side view to show the conventional paper punch, and

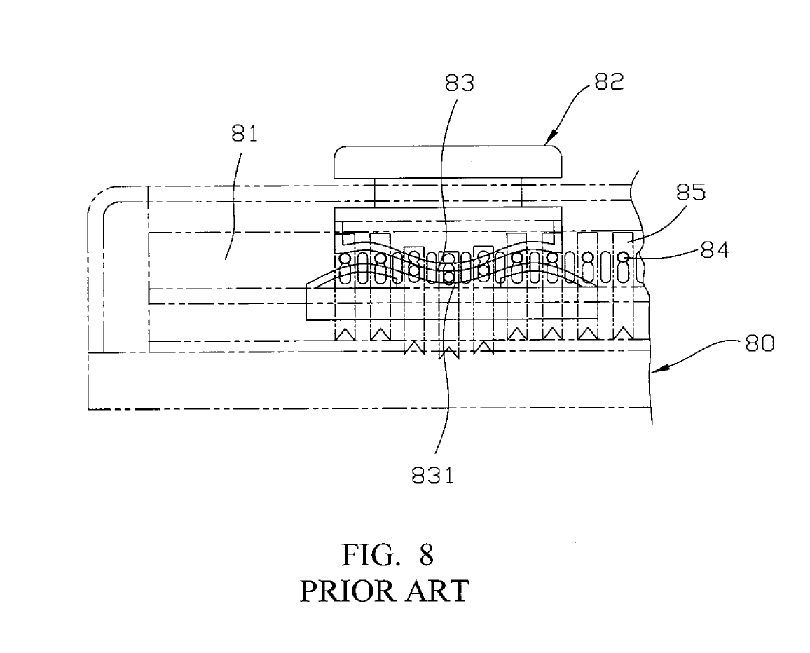

FIG. 9 shows that the blade cannot be changed in the conventional paper punch.

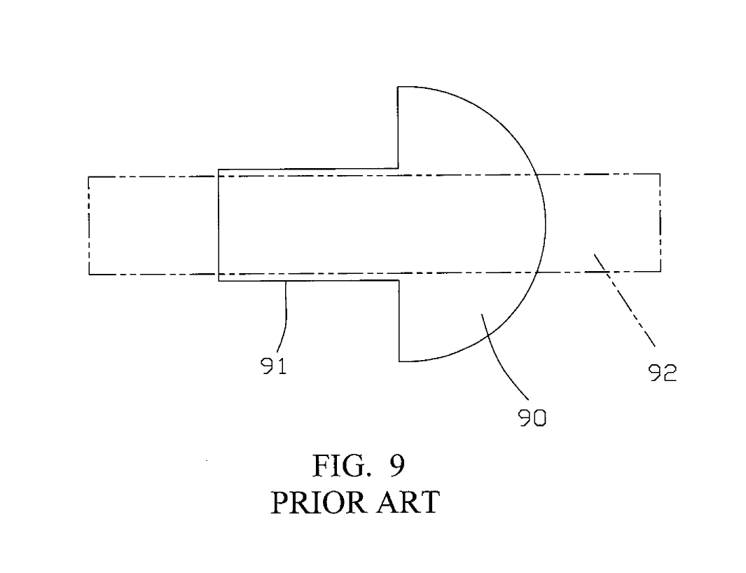

### DETAILED DESCRIPTION OF THE PREFERRED EMBODIMENT

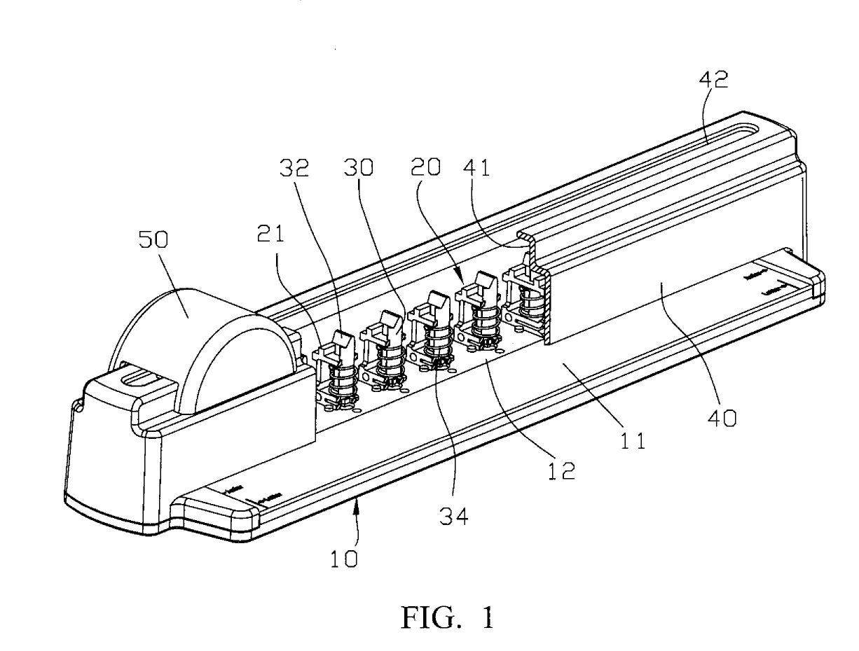

Referring to FIG. 1, the paper punch of the present invention comprises a base 10, a frame 12, multiple punch units 20, a cover 40 and a slide member 50. The frame 12 is connected to the base 10 and the cover 40 is mounted onto the punch units 20. The slide member 50 is slidable along the cover 40 and drives the punch units 20 to punch holes.

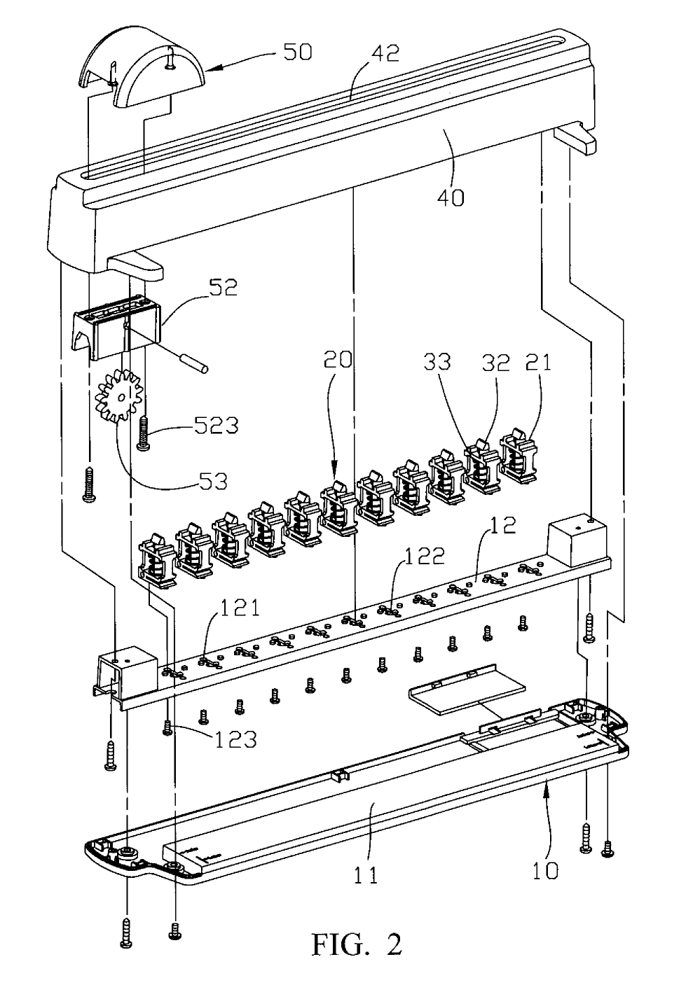

Referring to FIG. 2, the base 10 is an elongate base and a support face 11 extends from one side of the base 10. The frame 12 is fixed to the base 10 and located adjacent to the support face 11. The frame 12 has multiple positioning holes 121 and through holes 122 located alternatively to each other.

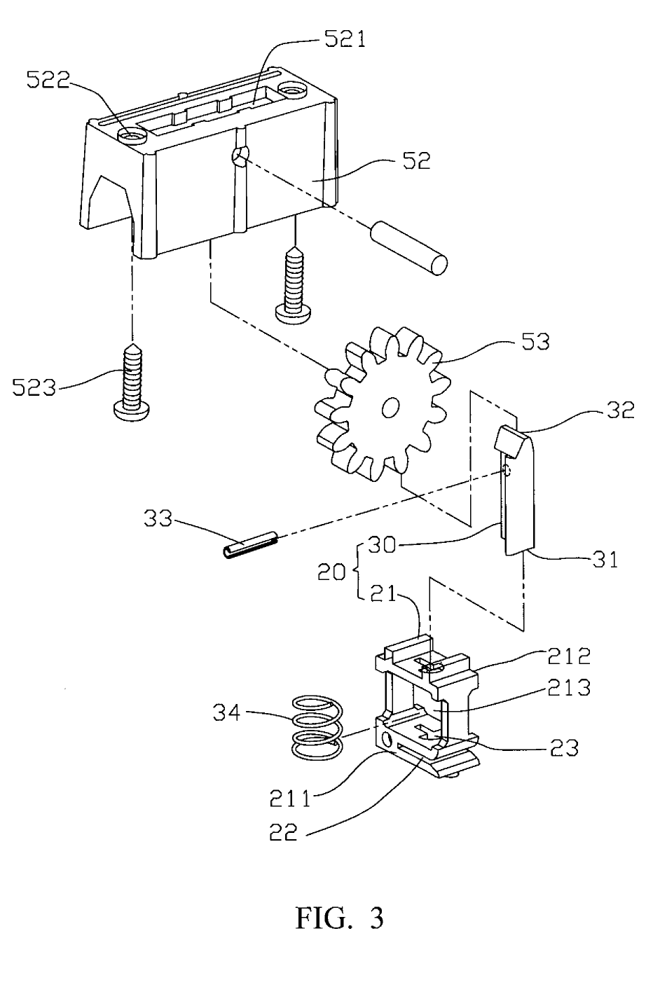

The punch units 20 are installed to the frame 12 as shown in FIGS. 2 and 3, and each paper unit 20 has a stationary punch body 21, a blade 30 and a spring 34. The punch body 21 is a hollow rectangular frame and has a top portion 212 and a bottom portion 211. An aperture 213 is defined between the top and bottom portions 212, 211. The bottom portion 211 has a slit 22 defined transversely which opens outward and perpendicular to the aperture 213 so that paper sheets can be inserted into the slit 22. The top portion 212 and the bottom portion 211 each have a passage 23 and the two respective passages 23 are located in alignment with each other. The passages 23 can be like mushroom passages or circular passages. The passage 23 of each punch unit 20 is located corresponding to the through hole 122 of the frame 12 so that the debris may drop into a proper position of the base 10 via the through hole 122. Multiple bolts 123 extend through the positioning holes 121 and fix to the punch body 21 so that the punch units 20 are fixed to the frame 12.

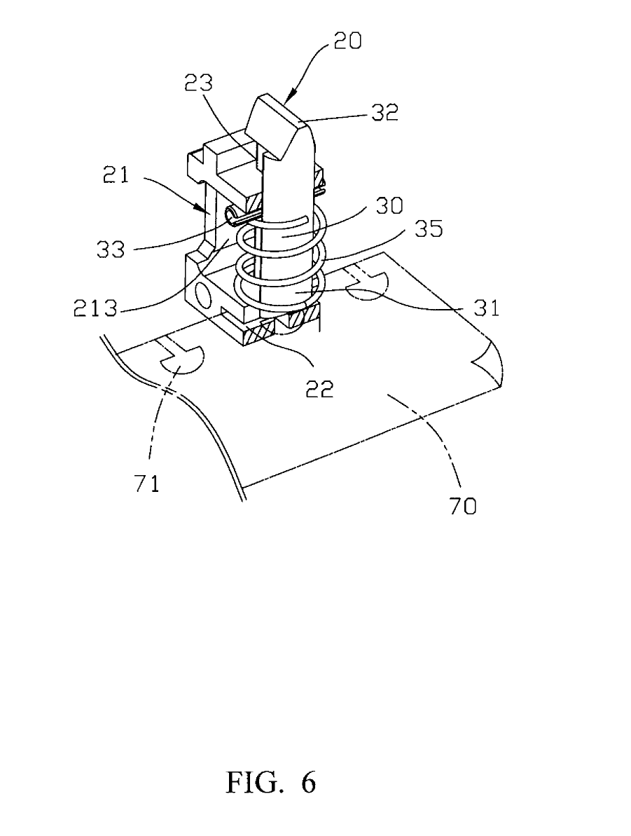

The blade 30 has a cross section complementary to the passage 23. The blade 30 extends through the passage 23 and has a first end thereof with a punch end 31 and a second end thereof being a passive tooth 32. A stop pin 33 extends through the blade 30 transversely and a spring 34 is mounted to the blade 30 from the first end of the blade 30. The stop pin 33 is perpendicular to the aperture 213 and biased by the spring 34 so as to contact against the punch body 21. As shown in FIGS. 3 and 6, when installing, the spring 34 is put in the aperture 213 and the punch end 31 is inserted into the passage 23 and extends through the spring 34 until the distal end of the punch end 31 reaches the top of the slit 22. The stop pin 33 contacts the top portion 212 of the punch body 21 by the spring 34 so that the blade 30 is prevented from dropping form the punch body 21 via the passage 23. The passive tooth 32 is exposed beyond the top portion 212 of the punch body 21.

The cover 40 is an elongate cover and has a space 41 defined therein which opens toward the base 10. A slide slot 42 is defined in the closed top of the cover 40 and faces the punch units 20 which are located along a straight line. The slide slot 42 communicates with the space 41.

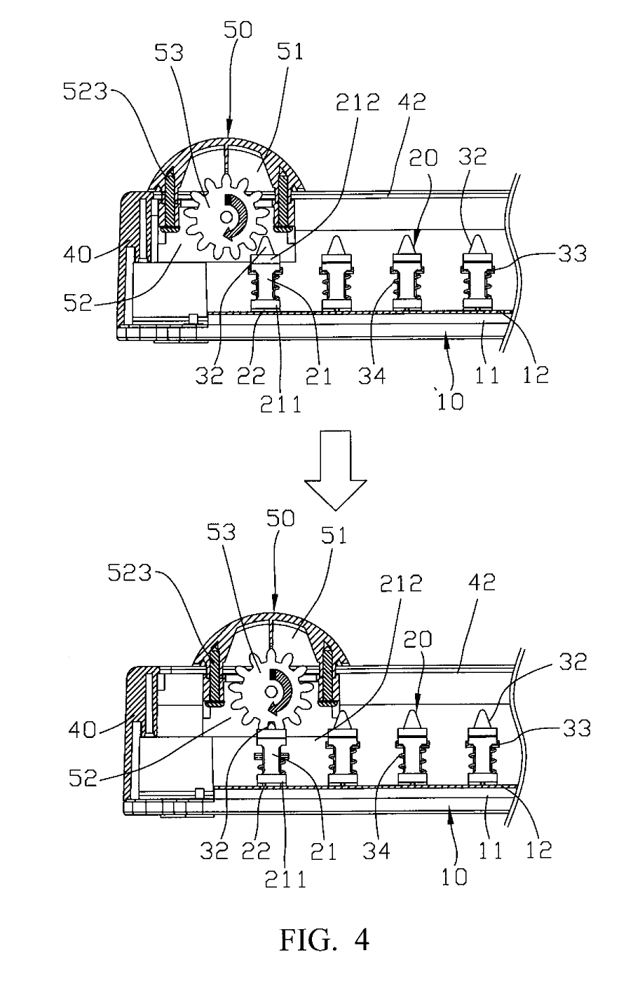

The slide member 50 is slidable along the slide slot 42 and an inner room 51 defined therein as shown in FIG. 4. An active gear 53 is located in the inner room 51. In this embodiment, the active gear 53 is located in a case 52 which is an inverted U-shaped case and has a closed top in which a top slot 521 is defined. The top slot 521 communicates with the inner room 51. The active gear 53 is movably located in the case 52 via the top slot 521. The case 52 has two holes 522 and two fixing bolts 523 extend through the holes 522 to fix case 52 in the inner room 51. When assembling, as shown in FIGS. 2 and 4, the slide member 50 is slidably mounted to the cover 40 and the case 52 is inserted into the space 41 of the cover 40. The top of the case 52 is located in the slide slot 42. The slide member 50 is mounted to the cover 40 and the fixing bolts 523 extend through the holes 522 and fix the case 52 to the inner room 51 of the slide member 50. The active gear 53 passes through the slide slot 42 and extends into the cover 40. The active gear 53 is engaged with the passive tooth 32 of the punch unit 20 when moving the slide member 50.

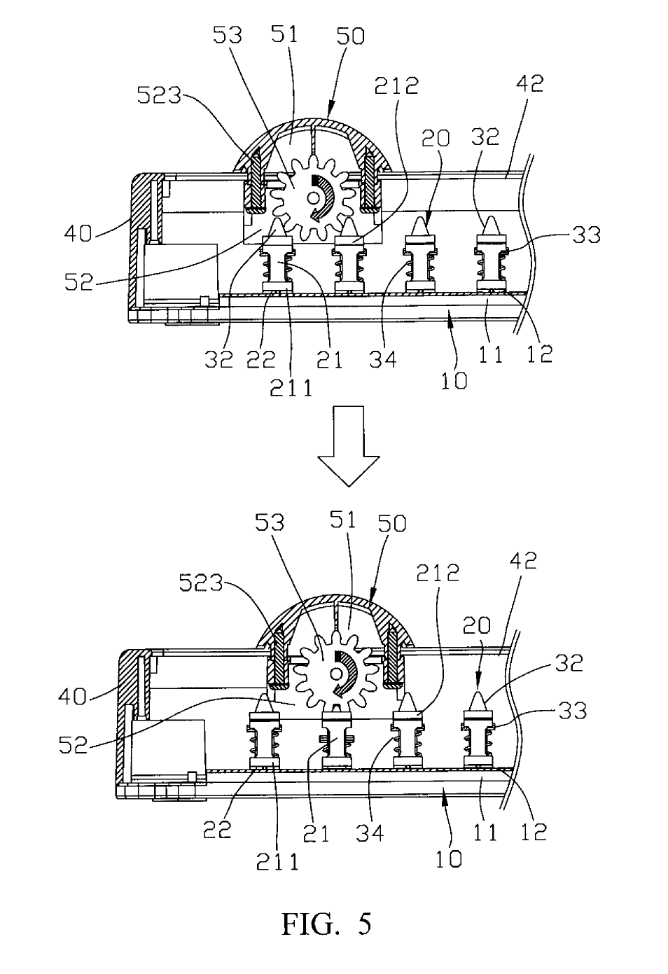

When in use, as shown in FIGS. 1, 4 and 5, the paper sheets are put on the support face 11 and inserted into the slits 22. The slide member 50 is moved so that the active gear 53 drives the passive teeth 32 of the punch units 20, the blades 30 are lowered. The stop pins 33 compress the springs 34 and the punch ends 31 of the blades 30 pass through the passage 23 to punch holes through the paper sheets. The punch units 20 lowered in sequence to punch holes along with the movement of the slide member 50. When the active gear 53 passes over the passive tooth 32 of the punch unit 20, the spring 34 brings the punch unit 20 upward, the stop pin 33 of the blade 30 is lifted to contact the top portion 212 of the punch body 21.

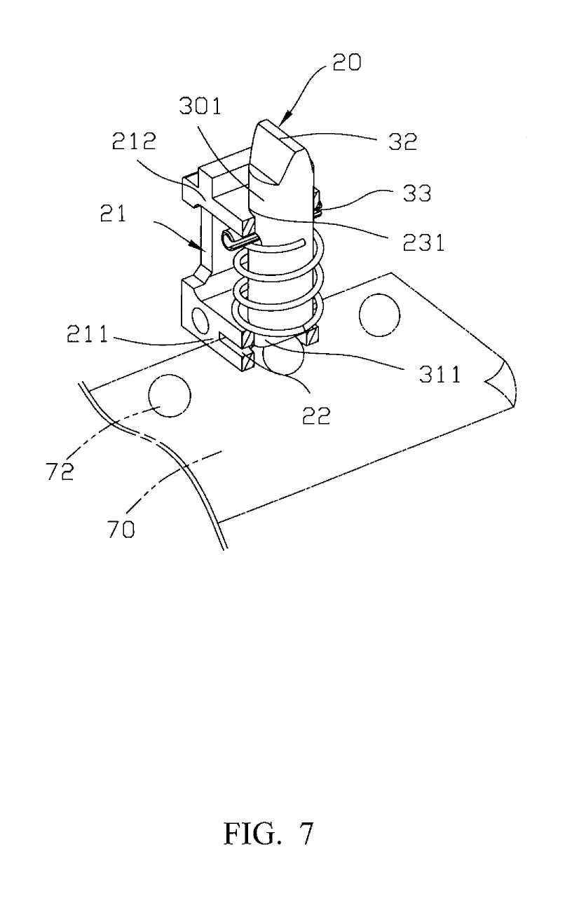

As shown in FIG. 6, when the cross section of the blade 30 is mushroom shaped, the holes through the paper sheets 70 that the paper punch made are mushroom-shaped holes 71. As shown in FIG. 7, when the cross section of the blade 301 is circular, the holes through the paper sheets 70 that the punch end 311 of the blade 301 of the paper punch made are circular holes 72. The blades 30, 301 with different shapes of cross sections can be used to punch different shapes of hole. The movements of the punch units 20 are made by the engagement between the active gear 53 and the passive teeth 32 of the punch units 20 when moving the slide member 50. The punch units 20 of the present invention allow the paper punch to punch different holes.

While we have shown and described the embodiment in accordance with the present invention, it should be clear to those skilled in the art that further embodiments may be made without departing from the scope of the present invention.

What is claimed is:

1. A paper punch comprising:
multiple punch units and each paper unit having a stationary punch body and a blade, the punch body having a passage defined therethrough, the blade having a cross section complementary to the passage, the blade extending through the passage and having a first end thereof with a punch end and a second end thereof being a passive tooth, a spring mounted to the blade, the blade being movable relative to the punch body by the spring;
a cover mounted to outside of the punch unit and having a closed top, a slide slot defined in the closed top, the slide slot facing the punch units which are located along a straight line, and
a slide member being slidable along the slide slot and having an active gear rotatably connected thereto, the active gear passing through the slide slot and extending into the cover, the active gear engaged with the passive tooth of the punch unit when moving the slide member, the blade being lowered and passing through the passage to punch holes.

2. The paper punch as claimed in claim 1, wherein the punch units are connected to a base which has a support face extending from a side thereof, a frame is fixed to the base and located adjacent to the support face, the frame has multiple positioning holes and through holes located alternatively to each other, the passages of the punch units are located in alignment with the through holes, the punch units are fixed to the positioning holes.

3. The paper punch as claimed in claim 1, wherein the punch body of each of the punch units has a top portion and a bottom portion, an aperture is defined between the top and bottom portions, the bottom portion has a slit defined transversely which opens outward and is perpendicular to the aperture, the slit is adapted to receive paper sheets, the top portion and the bottom portion each have a passage, the passive tooth is exposed beyond the top portion of the punch body.

4. The paper punch as claimed in claim 1, wherein the punch end of the blade of each of the punch unit extends through the passages and the spring is mounted to the blade, a stop pin extends through the blade transversely and is biased by the spring and contacts against the punch body.

5. The paper punch as claimed in claim 1, wherein the cover has a space defined therein which opens toward the base, the slide slot communicates with the space.

6. The paper punch as claimed in claim 1, wherein the slide member has a inner room defined therein, the active gear is located in a case which is an inverted U-shaped case having a closed top in which a top slot is defined, the top slot communicates with the inner room, the active gear is movably located in the case via the top slot, the case has two holes and two fixing bolts extend through the holes to fix case in the inner room, the active gear extends through the top slot and is engaged with the passive tooth of the punch unit.
